(19) United States
(12) Patent Application Publication
(10) Pub. No.: US 2007/0113090 A1
(43) Pub. Date: May 17, 2007

(54) Access control system based on a hardware and software signature of a requesting device

(76) Inventor: Agostinho De Arruda Villela, Rio de Janerio (BR)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/591,885

(22) Filed: Nov. 2, 2006

Related U.S. Application Data
(63) Continuation-in-part of application No. 10/598,719.

(30) Foreign Application Priority Data
Mar. 10, 2004 (BR) PI0400265-2

(51) Int. Cl. H04L 9/00

(52) U.S. Cl. 713/170

(57) ABSTRACT

A system and method for the authorization of access to a service by a computational device or devices, which may include a wireless device such as a cell phone or a smart phone. A software agent generates a digital signature for the device each time it attempts to access the service and send it to an authentication server, which compares the digital signature sent with one or more digital signatures on file to determine whether access to the service is permitted. The digital signature is generated by using hashes based on software and hardware configuration data collected from the device. The system may be used in conjunction with other authorization methods and devices.

This application is a continuation-in-part of and claims benefit of U.S. patent application Ser. No. 10/598,719, filed Sep. 8, 2006, which is a national stage application of PCT Application No. PCT/BR2005/000030, filed Mar. 10, 2005, which claims benefit to BR P10400265-2, filed Mar. 10, 2004, and is entitled in whole or in part to those filing dates for priority. The specifications, drawings and attachments of each of the above applications are incorporated herein by specific reference.

### FIELD OF THE INVENTION

The present invention relates to the identification of a variety of devices and methods for authorizing access to services. In particular, the present invention relates to controlling and authorizing access to sensitive and confidential information and services on a network or the Internet, including bank account information, corporate information, and commercial transactions and other forms of e-commerce.

### BACKGROUND OF THE INVENTION

The need for security of various levels when conducting transactions of various types over the Internet or similar environments is well established. The prior art describes several security-related devices and systems that are applied to allow users and devices of various sorts to access and operate services provided through networks or the Internet. Security needs have to be continually revised in face of the increasing sophistication of the means and mechanisms used to bypass security systems for fraudulent purposes, such as improper access to Internet banking and other resources. In countries such as the United States of America, the high level of continued efforts and investments made to prevent and thwart fraudulent and criminal activities illustrates the importance of guaranteeing user-friendly, secure, online transactions which involve private or confidential information.

In particular, in recent years the mobile data industry has been growing on many fronts, propelled in part by the explosive growth of the Internet and the consequent demand for mobile data access to the Internet, high penetration rates for users of mobile telephones, intense price competition among mobile network operators, and the emergence of worldwide standards for mobile data communications. The increasing number of consumers and businesses that expect to be able to securely access confidential information and conduct transactions wirelessly has created a great interest and demand for mobile device security.

Many online operations use sophisticated security procedures based at least in part on high levels of complexity in order to attempt to guarantee the security of these transactions. However, this increased complexity results in difficulties for legitimate users in accessing these services or conducting these transactions. This, in turn results in a lower than optimum level of adherence by legitimate users to using these security procedures, and decreases the willingness of these users to engage in these transactions.

One example of an apparently rigorous security scheme is that offered by online banking sites. These services behave as if only the user could visualize or access the service, and depend primarily on entry of a user password to validate access. However, authentication processes based solely on the user (i.e., user name and password) are susceptible to password tracking, password cloning, or the cloning of accessed webpages The presumed correspondence between a user and password thus facilitates fraud.

The mobile data market is not readily adaptable to the networks, applications, and devices used within existing wired solutions, due to fundamental differences between wired and wireless networks. In wired networks, there are standard device platforms, operating systems, and browsers, where data and content reside largely in databases, and data is extracted by the user on a simplified query basis using search engines—the user must either find or know where to get the information for which he or she is looking. Mobile, wireless networks currently have not such standards for client platforms, operating systems, or user interfaces. Mobile devices may be a PDA, a two-way pager, intelligent mobile device, or a smart phone.

Accordingly, what is needed is a system and method for enhanced security based upon the possession of a particular device that is able to complement or substitute traditional authentication procedures. In particular, the system and method should be fully functional for wireless networks as well as wired networks. In addition, the system should provide a strong two-factor authentication tool that is scalable and cost effect for mass use in online environments.

### SUMMARY OF THE INVENTION

The present invention is a system and method to substantially improve the security involved in an authentication process to access an Internet page, an Intranet page, or any other type of computer server or computer-based service or network that requires secure authentication. Any of these services will be cited hereinafter as a “SERVICE.” The authentication process includes a process related to the creation of a unique signature (a “SIGNATURE”) based on the hardware and software configuration profile of a device.

Whenever a user tries to access a SERVICE that is using the invention for authentication, either alone or in conjunction with other security processes or methods, the SIGNATURE resulting from the hardware and software configuration of the device from or through which the user is attempting to use or access the SERVICE is received, verified and compared to a list of authorized device signatures. If the current device's SIGNATURE matches one of the previously-registered signatures from this list, the user is allowed to access the SERVICE. If not, the user will either be directed to extended positivation or will be denied access to the SERVICE, depending on the previously chosen security options. In case the user is submitted to extended positivation, if his or her identification is successful, access to the SERVICE will be granted and the user will be given the option to include the present device in the list of authorized SIGNATURES for his or her account. If the identification is not successful, the user will not be allowed to access the SERVICE.

The invention can be used as a complementary authentication process to a separate authentication process, such as, but not limited to, an authentication method based on user/password pairs, so as to improve or increase the security related to a SERVICE. The invention also may be used independently to access less sensitive applications, such as logging onto a web portal or ISP.

In one exemplary embodiment, the invention is capable of performing authentication and identification without need for any other hardware or software components, such as smart cards, identification cards, or the like. The invention allows the recognition of a SIGNATURE for a device simply from the device's hardware and software components.

The specification herein offers a more in-depth description of possible applications of the invention; however, any application of the invention described herein is offered as an example, and should not be construed as a limitation to the scope of the claims.

### BRIEF DESCRIPTION OF THE DRAWINGS

FIG. 1 is a diagram that illustrates the basic operation of one exemplary embodiment of the present invention.

FIG. 2 is a diagram that shows the process of SIGNATURE deletion in accordance with one exemplary embodiment of the present invention.

FIG. 3 is a diagram that represents the deactivation of the invention's security system triggered by a user in accordance with another exemplary embodiment of the present invention.

FIG. 4 is a diagram that shows the steps of initializing one embodiment of the present invention.

FIG. 5 is a diagram that shows the steps of using one embodiment of the present invention.

FIG. 6 shows examples of embodiments of the present invention in use on mobile devices.

### DETAILED DESCRIPTION OF EXEMPLARY EMBODIMENTS

The present invention is a strong form of authentication that does not need external hardware devices. As described in detail below, the invention associates a user or user account with a trusted device (or devices). Each device has unique hardware and/or software characteristics, similar to the human genome. These unique characteristics, which may be thought of as the “digital DNA” of the device, are linked by the invention to a user or user account, creating a unique system of secure, reliable identification and authentication.

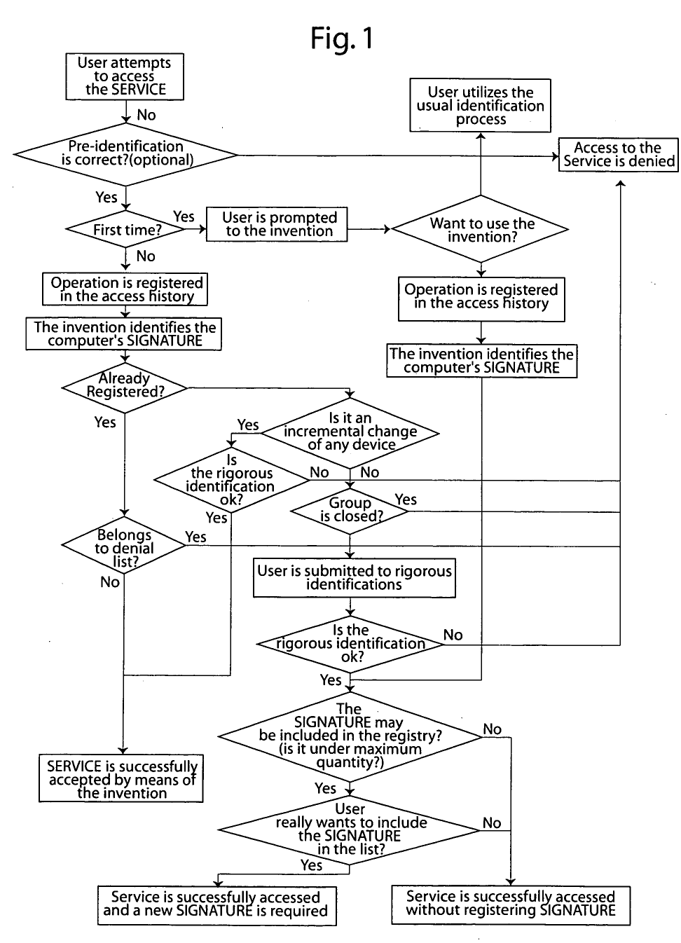

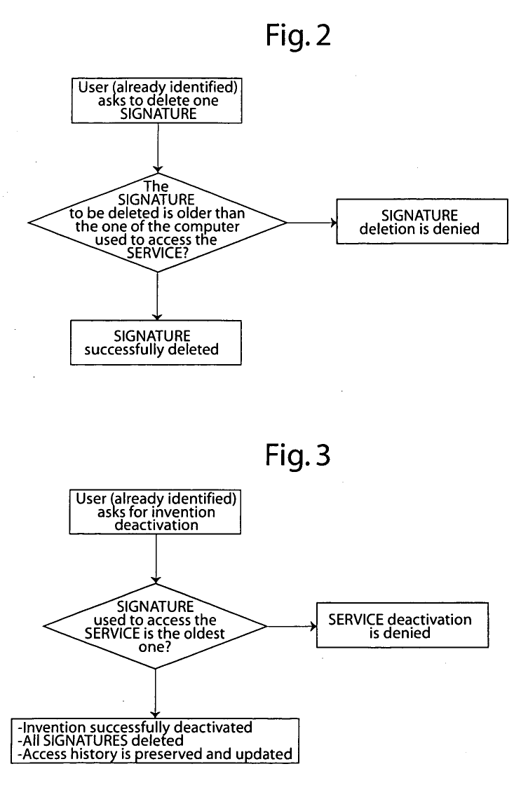

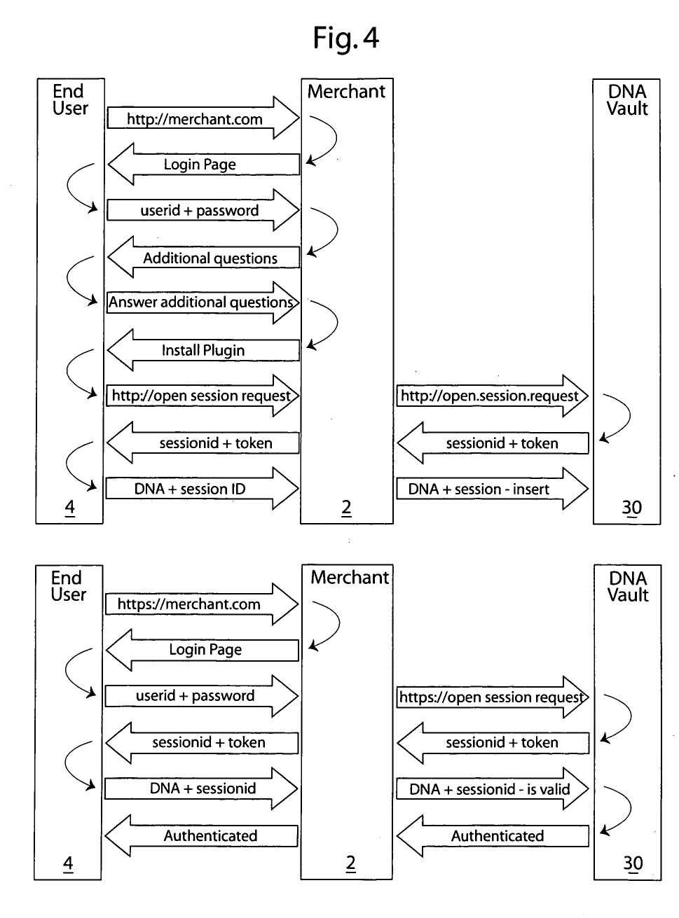

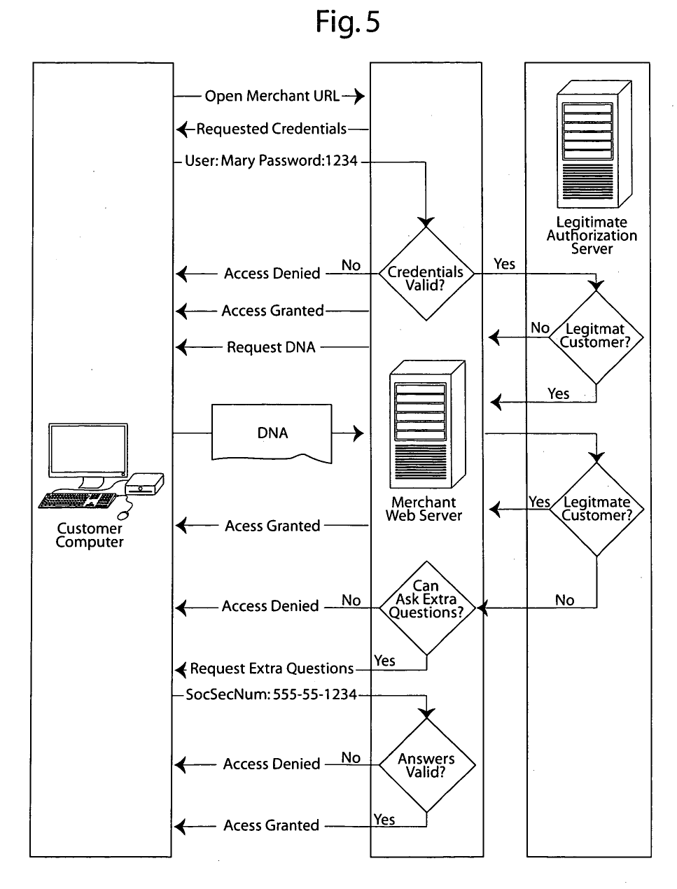

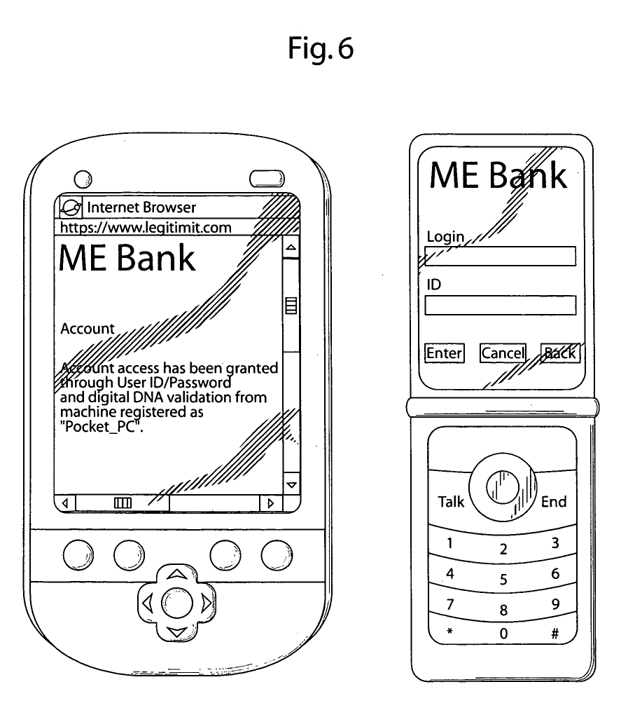

As seen in FIG. 1, in one exemplary embodiment, the present invention operates or is used in a distributed computational environment to provide secure access to a SERVICE 2 in, located on, or accessed through that environment. Examples of such an environment include, but are not limited to, the Internet, a local area network, or an internal computational network. Examples of SERVICES 2 include an Internet page, Intranet page, a banking or financial system, a corporate database, or any other type of computer server or computer-based service or network that requires secure authentication.

Typically, a user attempts to access a SERVICE 2 by means of or through a device 4. Examples of devices 4 include, but are not limited to, a personal computer, network terminal, cell phone, a personal digital assistant (PDA), a two-way pager, intelligent mobile device, or a smart phone.

A software agent 10 is used to detect hardware and/or software configuration information about the device 4. The hardware and/or software configuration information is used to create a SIGNATURE 20 for the device 4. The SIGNATURE 20 may then be compared to a list or set of authorized signatures for access to the SERVICE 2.

The software agent 10 may be deployed in a variety of forms, including, but not limited to, an Internet Explorer plug-in, a Netscape/Mozilla-Firefox plug-in, or Apple WebKit plug-in used by Safari. As a further example, in a Windows environment, plug-ins can be downloaded and installed by the browser (as a signed cab file or signed xpi file), or they can be downloaded as executable files.

The configuration information that may be collected and used to create a SIGNATURE 20 include, but are not limited to, hard drive serial number, CPU type and clock speed, memory type and physical location, physical MAC address, and other unique features of the device. The more separate data items collected, the greater the level of security and protection. The number of data items collected can be any number, including, but not limited to, ten items.

In one exemplary embodiment, the invention gathers this information directly from its source, and thus the software agent 10 should have direct access to necessary portions of a device's 4 internal systems. This may be only possible through an onboard agent.

As plug-ins can be exploited for illegitimate purposes, in one exemplary embodiment the invention uses a “self-protected” software agent 10 or plug-ins. Accordingly, the agent is a key part of the system and implemented as an executable object, allowing for the device to protect sensitive information while giving access to “hardware level” configuration data. In contrast to most plug-ins, which actively “listen” for an application that causes them to perform, and thus require that a port be open to insure the plug-in does not miss the network traffic and signal to trigger the plug-in, the agent of the present invention remains inert until called by the application using the present invention. The agent is not loaded to memory, and does not consume any CPU power until an external program calls its entry point, thus making it extremely difficult to exploit any vulnerability as the agent simply is not running the majority of the time.

To preserve user privacy, each element or component of this configuration information may be acquired and converted into a hash string. The hash strings may then be encrypted. In one exemplary embodiment, the hash string is wrapped in a one-time 128-bit encryption. The encrypted elements may be arranged in a unique pattern for each Web session or access attempt. A different encryption key may be used for each transmission.

In another exemplary embodiment, the calling of the agent 10 is conducted during a session initiated by the user and using a Secure Socket Layer (SSL) connection. The resulting inbound call to a specific port results in the agent 10 executing its program. The SSL session protects the invocation of the agent 10, as it is extremely difficult for an outside party to interject themselves into the transmission to try to exploit the agent 10. When the agent is asked to execute, it is loaded into memory, determines the SIGNATURE 20, and then opens an outgoing HTTP or HTTPS connection. The connection may be directly with an authentication server 30 or with the site using the invention. Once the connection is established, the agent 10 sends the SIGNATURE 20 and then closes the connection. Typically, this delivery takes less than one second. This behavior does not permit an outside party to exploit the agent 10.

In addition, the actual agent 10 may be constructed in such a manner that makes any attempt to reverse-engineer the agent extremely difficult. In one exemplary embodiment, the agent 10 is approximately 150 KB in size. In another embodiment, the agent 10 may be developed in C/C++ with a portion written in assembler and proprietary languages.

In an exemplary embodiment, an authentication server 30 receives the SIGNATURE 20 created by the software agent 10, and compares it to the authorized signature list to determine whether or not access to the SERVICE 2 may be authorized. The authentication server 30 should be in electronic communication, which may be wireless, with the device 4. The invention may thus be considered, in one embodiment, as an online authentication system.

The authentication server 30 may serve both as the means for interacting with the software agent 10 and the SERVICE 2 for determining whether access should be permitted, and as storage means. With regard to the latter, the authentication server 30 may serve as a repository of the list or set of registered or authorized SIGNATURES, as well as storing the history of access attempts by various users or putative users. In another exemplary embodiment, the list of registered SIGNATURES and access attempt history may be stored, separately or together, on some other server or in some other location. The invention is compatible with any form of database, including but not limited to, Oracle, MySQL, DB2, SQL Server, and the like. The database may be encrypted, which preserves the security of the data from anyone gaining unauthorized access to the database server. In another exemplary embodiment, the data is kept in a database indexed by user identification and a realm.

In one exemplary embodiment, the software agent 10 is installed on the device 4. The software agent 10 may be downloaded by standard means onto the device 4, including by means of web distribution techniques capable of downloading and executing a program in a single step or as a single process, such as, but not limited to, ActiveX or browser plug ins. The software agent 10 may be loaded onto the device 4 prior to or during the first attempt to access the SERVICE 2, during the setting up of an account with the SERVICE 2, or at some subsequent time for SERVICES 2 where a user already has access. The invention recognizes the browser or device type, and downloads the appropriate form of the agent 10. The deployment of the invention thus may vary from client to client, and may be voluntary or compulsory depending upon the environment.

The SIGNATURE creation process can be initiated at any time. In one exemplary embodiment, the process is initiated when the software agent 10 is downloaded and installed.

The invention may be used as the sole means of access to a SERVICE 2, although it may also be used to complement other authentication methods or security procedures. For example, in one exemplary embodiment, the invention may be used to deny the user access to the SERVICE 2 from a device whose SIGNATURE 20 is not registered or recognized. This may be used even though pre-identification could be successfully accomplished by means of other co-existing authentication processes (i.e., access may be denied even if a user/password pair are correct).

In one embodiment, the invention may be the last test of authentication for a web application. The scripting for the deployment and authentication calls may be placed on the web login page, as well as other pages that may be deemed to be high risk. The invention is invoked only after all other authentication processes (e.g., user name and password) have been completed. The providers of the SERVICE may elect to insure the identity of the user via additional methods, including challenge/response questions, or requiring the user to contact a call center or use a one-time password previously acquired. Once the existing authentication standards are met, the invention is called via scripting.

Upon installation on the device, the agent 10 collects the first set of configuration data and returns it to the authentication server, where it is maintained as the original SIGNATURE of that device. In some embodiments, the installation and collection of configuration data averages approximately 7 to 9 seconds, depending upon the connection and device processing speeds.

Once the agent 10 is installed and the initial SIGNATURE stored by the authentication server, future login sessions may be seamless to the user. For example, a web login page would receive the user name and password, and upon confirmation of that information, and prior to opening the SERVICE application, the invention causes a request to be sent to open a session. The authentication server opens the session, and sends to the application server a session ID and token, the token containing the seed number for both the one-time encryption key and shuffling mechanism. The token is passed to the device 4 via the connection (such as a SSL connection) established at the beginning of the session. Upon receiving the information and token, the agent 10 collects the configuration information, and hashes each of the configuration components. In one exemplary embodiment, the items are hashed using SHA256 hashing digest. The token information is used to encrypt the string of hashed component items, which also may be shuffled in a random order. This happens each and every time a request for authentication occurs, and thus may prevent replay attacks. The resulting encrypted string is sent to the authentication server, where it is decrypted and checked against the original SIGNATURE for a “pass” or “no pass” decision, which is passed back to the web server where it is then applied to the current session. This process may take less than a second from login to authentication.

The call for authentication may be invoked at any time during the session, thus making the present system particularly effect for preventing man-in-the-middle attacks. This can be controlled by embedding scripting on the application pages that contain high risk transactions, such as movement of money or adding bill payees.

The authentication server 30 may have a set of rules that allows some changes to the device, whether in software or hardware, without the device becoming unauthorized.

An example of the operation of the present invention when used for access to a SERVICE is illustrated by the following steps:

1. A user attempts to access a SERVICE through a device. If the present invention is used in conjunction with other authentication processes or security procedures (e.g., pre-identification), such as, without limitation, username/password pairs, verification of authorized IP address ranges, answering of specific questions, optical character recognition or similar services that protect against “software robots”, or the like, then the user may be required to pass or satisfy those other authentication processes or security procedures first. Alternatively, those other authentication processes or security procedures may be implemented subsequent to the authentication system of the present invention, or in cases where multiple procedures are used, some may occur before and some may occur after the authentication system of the present invention.

2. If this is the first time the user has attempted to access the SERVICE after the present invention has been implemented for the SERVICE, or if the user has not already registered any device SIGNATURE for the SERVICE, then the user may be prompted to download the software agent in order to initiate the process of the present invention. The user may be directed to a web page or software window as a part of this process, where the user is given information about how the invention works and/or describing the registration process required for access.

In an exemplary embodiment, this step may be implemented so as to be optional, when the provider of the SERVICE desires to offer the user the option of accessing the SERVICE through means of the invention as one of several authentication processes or means. Similarly, the user may also have the option of deactivating or reactivating the use of the invention when desired. In such a case, a user desiring to reactivate the present invention may be required to identify themselves in some way (e.g., user/password pair, answering questions, and the like) prior to reactivation. Further, as described in greater detail below, deactivating the use of the present invention by a user may be permitted only from the device that has the oldest SIGNATURE registered for the user's account, based on the presumption that the oldest SIGNATURE is likely to be the most trustworthy SIGNATURE.

3. Once the user has agreed to the use of the invention, he or she must allow the software agent to download and execute on his or her device, unless this has already occurred. This step must be repeated for each device that will be submitted to the authentication process of the present invention.

4. Once the software agent is installed on the device, it collects data sampled from the device's hardware or software components, or both. The software agent then creates a SIGNATURE for the device from the sampled data, and submits it for registration with the SERVICE, or for authentication, as appropriate. The SIGNATURE identifies the device without the need of any supplementary identification device or means, such as a smart card. In some embodiments, the first registration may not require rigorous authentication.

The device's identification is done by detecting and identifying essential hardware and software components of the device. The invention allows incremental changes to some of these components without modifying the device's SIGNATURE. However, if the device has undergone substantial modifications in its hardware or software configurations, its SIGNATURE likely will be changed. This means that the device will be considered as a new device and will not be recognized by the SERVICES accessed before the modifications. In this case, the user has to register the new device SIGNATURE. Minor changes of components that generally are not considered to be essential may be done without affecting the SIGNATURE.

In one exemplary embodiment, the SIGNATURE comprises one or more groups of information hashes generated based on the hardware and software components. These hashes cannot be reversed to recompose the information used to make the SIGNATURE, thereby preserving user privacy and security. In one embodiment, the hashes be grouped in a different way for each transaction, and submitted to several levels of cryptography. This procedure protects against anyone who attempts to intercept the communication between the user device and the authentication server or SERVICE, and may try, by simply reproducing the transmitted data, to pretend to be the original device.

5. In one embodiment, if the user attempts to access the SERVICE from a device that was not previously registered, then the invention will allow access only after application of extended positivation means (e.g., specific questions in addition to username/password pairs). In another embodiment, this access may be allowed only if there was at least one device previously registered with the SERVICE. If the extended positivation means is successfully passed, then the user will be allowed to access the SERVICE, with the option to register the present device's SIGNATURE. If the extended positivation means is not successfully passed, then access is denied.

Optionally, the user may be limited to a determined quantity of SIGNATURES associated with his or her account (the quantity may be defined in accordance with the needs of the SERVICE). It thus is possible to create a closed group of devices and limit the SIGNATURE set that can access the SERVICE for a given account. The user may have the ability to choose the number of SIGNATURES able to access the SERVICE through his or her account, although this limitation may be set by the provider of the SERVICE. In the case where the user has reached this determined quantity of SIGNATURES, he or she may be able to choose whether or not the number of SIGNATURES should be limited to this quantity. These options may be implemented in a mandatory way; that is, the user will be able to register additional SIGNATURES coupled to his or her account until a maximum number is reached. Alternatively, the limitation may be based on some other measure, such as only devices that belong to a specific group or type.

In another exemplary embodiment, even in the case where additional SIGNATURES are not permitted to be registered, it may be possible to optionally access the SERVICE from a non-registered device by means of extended positivation, examples of which are described above. The SIGNATURE of this device cannot be added to the existing list of authorized signatures, although the SIGNATURE of this device may be stored as part of the history of access attempts. The SERVICE access from this device thus may be performed as a detached and temporary operation. The invention also allows for sessions where no SIGNATURE may be collected, such as cybercafé or business offices, multiple users on the same machine, and similar settings.

In yet another embodiment, it is possible to specify a maximum number of times a SIGNATURE can be present in the authorized signature lists of different users of the SERVICE. This maximum number may even be set to zero where the device creating the SIGNATURE is one to which access will be denied, such as when the device is considered to be a “malicious” device. The device thus may be included in a denial list for devices that are not authorized to authenticate.

6. Whenever necessary, the user may delete one or more SIGNATURES registered for his or her account. In one embodiment, the deletion process may be limited so that SIGNATURES may only be deleted through a device registered at an earlier time with the SERVICE, based on the presumption that the earlier devices are more secure and/or trustworthy. This creates, in effect, a hierarchy of devices (and concomitant SIGNATURES) based on chronology (i.e., the date of registration with the SERVICE). A hierarchy can also be based upon other factors, such as the type of device, or a combination of these factors. Accordingly, a user may only delete a given SIGNATURE if the user is using a device higher up in the hierarchy than the device associated With the SIGNATURE being deleted, or, in a variation of this embodiment, by the device associated with the SIGNATURE being deleted. In any of these embodiments, the oldest SIGNATURE may be deleted only through the device creating that SIGNATURE.

7. In one embodiment, the invention stores (and thus is able to provide) historical information about all accesses or access attempts performed upon or through a user account. This history may be kept and stored even if the user decides to deactivate, even temporarily, the use of the present invention.

It should be noted that the present invention works equally well in the wireless environment, such as with cell phones or smart phones. In one exemplary embodiment, the agent is compatible with Symbian OS, which is the operating system on the majority of smart phones, as well as Windows Mobile 2003 and 2005. This use of the invention allows all online banking and ecommerce provides to extend their operations to the mobile market while still maintaining significant security.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A method for identifying devices and controlling access to a service, comprising the steps of:
collecting data related to software and hardware configurations from a device through a software agent;
generating a digital signature for the device by hashing the software and hardware configuration data; and
sending the digital signature of the device to an authentication server.

2. The method of claim 1, wherein the digital signature sent to the authentication server is encrypted.

3. The method of claim 1, wherein the software agent is installed on the device as part of the process of using the device to access a service.

4. The method of claim 1, wherein the hashes used to generate the digital signature are changed with every attempt to access a service, and the hashes cannot be reversed.

5. The method of claim 1, wherein the digital signature is one of several stages of a framework of authorization and authentication processes governing access to the service by the device.

6. The method of claim 1, wherein the authentication server compares the digital signature sent with one or more previously-stored digital signatures.

7. The method of claim 6, wherein the authentication server determines whether the device has been excluded from accessing or enrolling in the service by determining whether the device is on a list or in a group of devices not allowed to access the service, or is included within a group of devices allowed to access the service.

8. The method of claim 6, wherein the authentication server allows a maximum number of enrollments for a particular device.

9. The method of claim 8, wherein the maximum number of enrollments is zero.

10. The method of claim 6, wherein the authentication server allows minor modifications to the software or hardware configurations of a previously-enrolled device so as to preserve access or denial of access for the device.

11. The method of claim 10, wherein the previously-stored digital signature of the device is updated to reflect the modifications.

12. The method of claim 1, wherein the authentication server logs all accesses or attempted accesses by a device to the service.

13. The method of claim 1, wherein multiple devices can be registered for a single user with the authentication server to create a registration hierarchy.

14. The method of claim 13, wherein a user can unregister a device only through the device itself, or another device within the registration hierarchy registered earlier than the device to be unregistered.

15. The method of claim 1, wherein the device is a wireless device.

16. The method of claim 1, wherein the device is a cellular or smart phone.

17. A method for identifying devices and controlling access to a service, comprising the steps of:
registering a device with an authentication server for access to the service; and
verifying the identity of the device each time it subsequently attempts to access the service.

18. The method of claim 17, wherein the step of registering a device comprises the steps of:
collecting data related to software and hardware configurations from the device through a software agent;
generating a digital signature for the device by hashing the software and hardware configuration data;
sending the digital signature of the device to the authentication server;
verifying that the device is not on a list or in a group of devices not allowed to access the service, or is not a device with a maximum number of enrollments set to zero;
and registering the device as authorized to access the service.

19. The method of claim 17, wherein the step of verifying the identity of the device comprises the steps of:
collecting data related to current software and hardware configurations from the device through a software agent;
generating a digital signature for the device by hashing the software and hardware configuration data;
sending the digital signature of the device to the authentication server; and
comparing the digital signature sent with one or more previously-stored digital signatures for the device.

20. The method of claim 17, wherein the step of verifying the identity of the device comprises the steps of:
collecting data related to current software and hardware configurations from the device through a software agent;
generating a digital signature for the device by hashing the software and hardware configuration data;
sending the digital signature of the device to the authentication server; and
verifying that the device is not on a list or in a group of devices not allowed to access the service, or is not a device with a maximum number of enrollments set to zero.

21. A system for identifying devices and controlling access to a service, comprising the steps of:
a software agent installed on a device, adapted to collect data related to software and hardware configuration of the device;
a digital signature for the device, generated by the software agent by hashing the software and hardware configuration data; and
an authentication server that determines whether the device can access the service based upon the digital signature of the device.
